(19) United States
(12) Patent Application Publication
(10) Pub. No.: US 2009/0234755 A1
(43) Pub. Date: Sep. 17, 2009

(54) SYSTEM AND METHOD FOR PURCHASING A GIFT

(76) Inventor: Trel W. Sidoruk, Northport, NY (US)

Correspondence Address: Locke Lord Bissell & Liddell LLP;Attn: IP Docketing, Three World Financial Center, New York, NY, 10281-2101, US

(21) Appl. No.: 12/245,358

(22) Filed: Oct. 3, 2008

Related U.S. Application Data
(60) Provisional application No. 61/037,035, filed on Mar. 17, 2008.

(51) Int. Cl. G06F 17/30; G06Q 30/00; G06Q 10/00

(52) U.S. Cl. 705/27; 705/26; 705/1

(57) ABSTRACT

The invention relates to a web based gift selection and ordering System comprising a web-based interface for Sender interaction and the entering of data; a database to store and allow access to that data; AI software to act upon that data to determine the appropriate gift; and a portal to e-commerce vendors on the internet to purchase the gift and have it shipped to the Recipient.

### BACKGROUND

Finding the right gift for someone is often a difficult process. People often spend a large amount of time, money and energy in finding an appropriate gift only to receive a tepid response from the gift Recipient. Alternatively, many people lead very busy lives and either lack the time necessary to select an appropriate gift, consequently selecting one in a haphazard fashion, or altogether forget to buy a gift because they are too busy. Either way, this leads to disappointment on the part of the intended Recipient.

For the foregoing reasons, there remains a need for a web based gift selection and ordering System that determines an appropriate gift for a Recipient.

### SUMMARY

Accordingly, it is an object of the present invention to provide a System that utilizes a web based interface, artificial intelligence software (“AI software”), a database and portals to e-commerce vendors for ordering. The System may also utilize social networks, such as LinkIn, Myspace and/or Facebook. The gift Sender enters information about itself and the gift Recipient through a web interface into a Profile stored in a database. AI software determines an appropriate gift to send the Recipient based upon this information stored in the database. To determine an appropriate gift, AI may also utilize other readily available resources on the Internet that match that Recipient, i.e. their profile on MySpace, and/or their shopping favorites on Amazon (i.e., wish list items). The gift is then purchased and shipped by portals to e-commerce vendors on the Internet.

The present invention is directed to a web based gift selection and ordering System that satisfies the need for determining an appropriate gift for, and having that gift shipped to, a Recipient. A gift selection and ordering System having features of the present invention comprises a web-based interface for Sender interaction and the entering of data; a database to store and allow access to that data through the use of Profiles; AI software executed by a processor in a computer system to act upon that data to determine the appropriate gift; and a portal to e-commerce vendors on the internet to have the gift purchased and shipped to the Recipient.

One embodiment of the instant invention provides for a web based gift selection and ordering System that provides for the purchase of a perfect gift for a future occasion. This System reduces the risk that the Sender will forget this special occasion. A Sender enters personal information about itself (such as the amount of money it wishes to spend on a Recipient) and a Recipient (such as its likes and dislikes, age, sex, etc) into a database, as well as the date of a future occasion. The system may then check independent outside sources of information on the Recipient, which run the gamut of online stored personal information, such as online social networks, like MySpace.com and FaceBook.com, to purchase portals, such as, for example, Amazon and OverStocked.com. This information is then utilized by the AI software to select an appropriate gift(s) for the Recipient. After the gift is selected, the System communicates with e-commerce vendors on the web and ensures that gifts are purchased and automatically sent to the Recipient for arrival on or before the occasion date.

An additional embodiment provides for a web based gift selection and ordering System that provides for the purchase of gifts for immediate purchase. This System reduces the risk that a Sender will waste valuable time selecting an inappropriate gift. The System first asks the Sender whether it wants the present wrapped and shipped directly from the e-commerce vendor to the Recipient. Then, the System prompts the Sender with a series of questions (Initially, there are three sets of questions, each set containing a certain amount of questions) used to obtain personal information about the Recipient (such as its likes and dislikes, age, sex, etc). These answers are entered into Recipient's Profile in the database. After each set of questions is answered, the Sender is provided with five gift choices. If a Sender exhausts all three sets of questions without selecting a gift, the Sender can then proceed in one of two ways: (1) the user can either continue with the AI software determination process for free; or (2) have a professional help them with the selection process live, through electronic means.

These and other features, aspects and advantages of the present invention will become better understood with reference to the following description, appended claim and accompanying figures.

### FIGURES

In order to understand the invention more fully, reference is directed to the accompanying Figures which are to be taken in conjunction with the Detailed Description of the Invention:

FIG. 1 is a screen-shot of a web page with a list of questions requesting general information about the Recipient and would-be answers provided by Sender.

FIG. 2 is a list of information provided to the System by the Sender.

FIGS. 3-5 are screen-shots of web pages each with a set of Fire-and-Forget questions requesting specific information about the Recipient and would-be answers provided by Sender.

FIG. 6 is a screen-shot of a web page with a list of sample gift ideas presented to Sender.

### DETAILED DESCRIPTION OF THE INVENTION

A web based gift selection and ordering System according to the present invention comprises a web based interface; a database; AI software; and a portal to e-commerce vendors on the internet.

The web based interface provides for Sender interaction with the System and allows for the input of personal information of the Sender and gift Recipient into the database. This information may include, but is not limited to, descriptive characteristics (such as age, sex and marital status) and financial aspects (such as how much a Sender is willing to pay for a gift and whether they want to use point rewards to pay for the gift).

This information is stored in a relational database in the form of a Profile. When information is entered regarding a gift purchase, a Profile is created for both the Sender and the Recipient. These Profiles are accessible to other users of the System. Also, because these Profiles are stored in a relational database, they can be updated by other embodiments of the present invention. For example: The second embodiment discussed is a System for purchasing presents “now.” This System can access the same database utilized by other embodiments of the instant invention. By linking embodiments to the same relational database, any embodiment of the present invention will be able to access all Profiles created, regardless of which embodiment created them.

The AI software accesses the information in the Profile to determine the appropriate gift(s) for the Recipient. The more these Profiles are utilized and updated, the more appropriately the AI software can select the gift(s).

The portal to e-commerce vendors allows the purchase and shipment of the gift(s) to the Recipient.

### One Embodiment

Many people lead busy lives. For these people it is often difficult to remember birthdays, anniversaries and the like. Or, even if they do remember, they do not have the time to select a gift for their friends, family and/or acquaintances. This will routinely lead to a failure to provide a gift for that special occasion. Therefore, according to one embodiment of the present invention, the gift Sender can utilize the present invention to purchase gifts for future occasions without having the burden of selecting an appropriate gift or even remembering the occasion.

Upon accessing the future present web interface, a Sender will be prompted to choose whether it intends to purchase a gift for immediate purchase (according to the second embodiment of the present invention) or for a future occasion. If the Sender chooses to make an immediate purchase (according to another embodiment of this invention), it will be directed to another web interface dealing with immediate purchases. If the Sender wishes to make a purchase for a future occasion, the Sender will be prompted to proceed with the following steps:

### Sender's Information

The Sender begins by entering its personal information through the web interface. This information is stored in a database in the form of the Sender's Profile. (For example, name, age, address, credit card information, etc.). The Sender can also enter who they are in relation to the rest of their world. For example: (John Doe: Husband; Father; and Grandfather).

These are the most important fields (who the Sender is in relation to the world). If Sender checks off Husband, the database will ask for the name of its spouse. The Sender can also input the last 5 gifts he gave his spouse and rate (scale of 1-10) what it believes her level of satisfaction was on those gifts. For example: Birthday—Hairdryer—7; Anniversary—Diamond necklace—9; Christmas—Bike—6; Valentine's Day—Beauty spa treatment—8; Mother's day—Dress—5. Similarly, the Sender can enter a price range on a prospective Recipient's gift. For example: Matt (my son), I will spend $100 on his birthday—$130 at Christmas—$50 on his birthday. A member can also make a pre-selection for certain relations. For example: My Mother In-law only wants gift cards because she feels no one knows her tastes. A Profile will automatically be created for every person who is scheduled to receive a gift, and any information entered about a Recipient will be entered into this Profile. All this data is utilized by the AI software to select a perfect gift.

The interface will also ask the Sender for its personal “point clubs” information, i.e., travel rewards programs, and frequent flyer programs, which would allow it to pay for a gift with the points it has accumulated in the various programs. Many point offerors, like Starwood Hotels, have specials that run all the time on items they are looking to offload. All point companies will be a source of income for the site by simply charging the company (Starwood hotels, Hilton, American Airlines, Delta, etc. . . . ) a small processing fee for that transaction. A Sender may also input in its Profile that it would like “deals from point clubs” searched for only certain occasions. For example: An anniversary would have vacations checked on all Sender's point programs so he could give that to his wife. Point clubs are also a rich resource for personal preference information on a purchaser. If many “travel packages” are purchased by the purchaser during a certain time of year (e.g., fall), then the AI can determine that “Getaways” are preferred over conventional gifts if no initial preference is stated by the purchaser during that time of year for gifts for his wife.

Also, a Sender can enter gifts it wants into its Profile (remember, a Sender today is a Recipient tomorrow). Other Senders will be able to access this information in making their respective purchases. For example, Sender wants an iPhone. If another user of Future Present wants to buy Sender a gift, the System will notify the user that the member has listed a specific gift. The System will then give the user the choice of either buying that iPhone, having the AI software selecting a new gift, or selecting a gift on its own. If the Sender has also inputted a budget of $100.00 for the gift Recipient, it would not be shown the iPhone because the iPhone costs more than that. However, because the recipient has listed the iPhone, the AI software will place a great deal of value on gifts that complement the iPhone that are within the Sender's budget (e.g., iPhone carrying case valued at $50). The system (with recipient's/purchaser's expressed written permission) would access all of their user profiles on web purchase portals, such as Amazon.com and cross reference the “wish list.”

The interface will ask for the Profile information in stages to keep the pace of the website moving. A person with little time is unlikely to complete all the requested data entry. To address this problem, a reminder email can be sent to Sender at a later date (this embodiment also contains an email-server to be used for marketing and advertising, order confirmations and notifications, and other communicative purposes). Or, after the preliminary Profile is inputted, a Profile update email is presented with an instant savings reward to entice the Sender to fill in more information about themselves and anyone else they know. For example: Free shipping or X % off price.

This invention will also prove useful for a Sender's sales and marketing efforts in its personal career. Many software packages remind salespeople when a client's birthday is approaching, but the salesman must follow up on that reminder. Typically, either the salesperson or its assistant must to go out and look for a gift and send it. To circumvent this bottleneck, the database could be linked directly in to a Sender's client retention management software database like Salesforce.com or Sugarsnap. By linking these two databases, the System could automatically send out gifts, cards, or both, to these contacts.

This Profile, along with those of Recipients, can be made available to the general public, or restricted to certain other Profiles stored in the database.

### Recipient's Profile

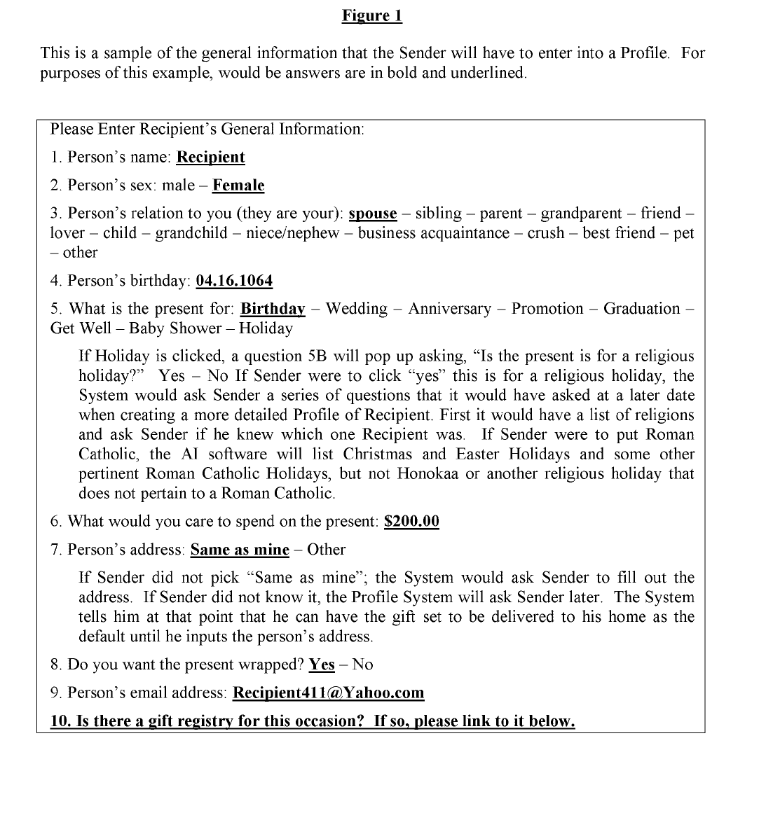

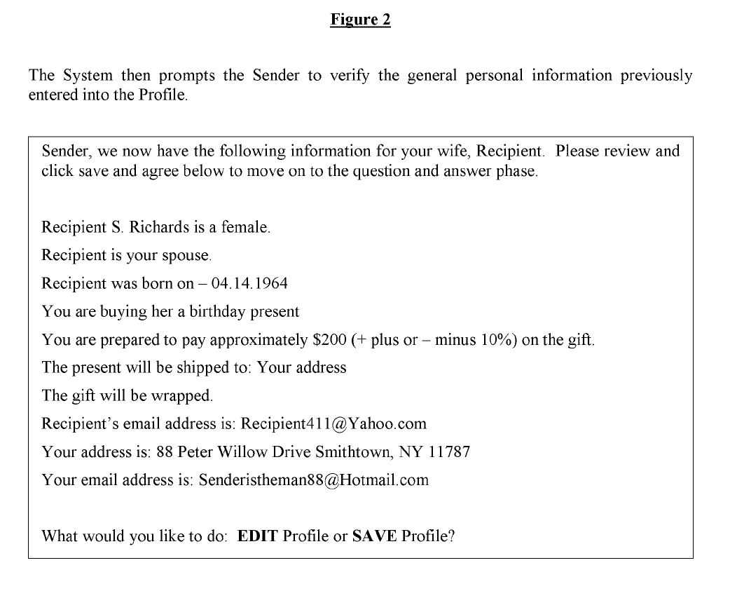

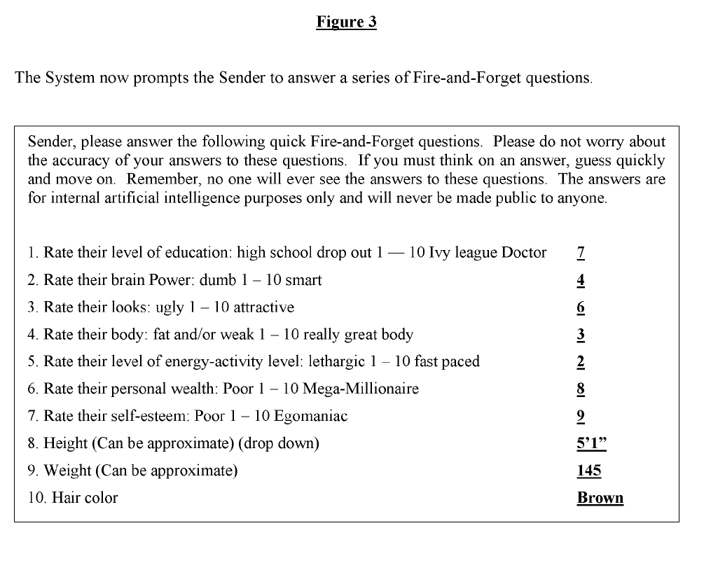

After Sender enters its personal information, the Sender will be prompted to enter general information [FIG. 1] into the gift Recipient's Profile (Including, most importantly, the date the future present is supposed to arrive, e.g., birthday, anniversary, etc.). After the information has been entered and submitted, the System will prompt the Sender to either edit or save the previously entered information [FIG. 2].

The Sender will then be provided with certain options:

The Sender can allow the System to automatically choose a gift based on the general information that was previously entered. If the Sender chooses this option, the determined gift will be automatically purchased and shipped (Ensuring delivery on or before the occasion date) by the retailer/wholesaler/distributor to the Recipient with a personalized card (if the Sender so chooses).

Instead, the Sender could choose to have the System provide 5 gift choices to Sender, via email (Or other means), a specified time (e.g., 14 days) before the occasion date. Sender would then be able to choose one of the gift options for the System to deliver to Recipient. If for some reason the Sender fails to respond to this email, the System will automatically pick a gift when necessary to ensure delivery on or before the occasion date. The System will then notify the Sender of its default as well as the gift that was chosen and sent to the recipient.

Also, the Sender could choose to provide the Recipient the opportunity (through email or other means) to pick from 5-10 gifts selected by the AI software.

The Sender could also choose to have the System send Recipient an email requesting that it work directly with the System (i.e., answer questions to update Recipient's Profile) to aid the AI software to select the perfect gift.

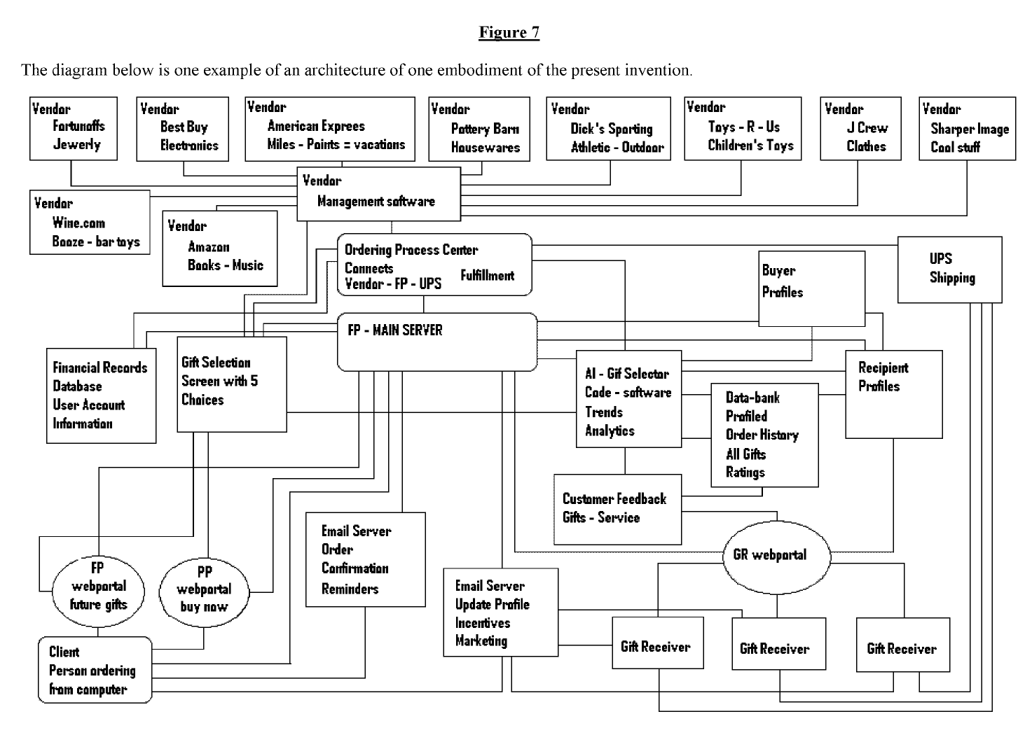

Or, the Sender can continue on by answering three sets of questions. These questions are Fire-and-Forget questions, i.e., the System notifies Sender that all questions should be answered quickly, and that no one will ever see the answers. The answers are utilized by the AI software to help choose the perfect gift [FIGS. 3-5].

Assuming Sender chooses to answer the three sets of Fire-and-Forget questions [FIGS. 3-5], the AI software will then assign each of the answers an internal point value (in order to aid it in choosing the perfect gift) depending on how well Sender answered them. Answers of “I don't know” may bring down the overall accuracy of all the questions as a whole because Sender may not know much about Recipient's likes and dislikes. However, the fact that Sender does not know what music Recipient listens to, doesn't necessarily mean that he may be wrong about Recipient's body type, etc. All of this will be considered by the AI software in assigning point values to answers and thus, in selecting the perfect gift.

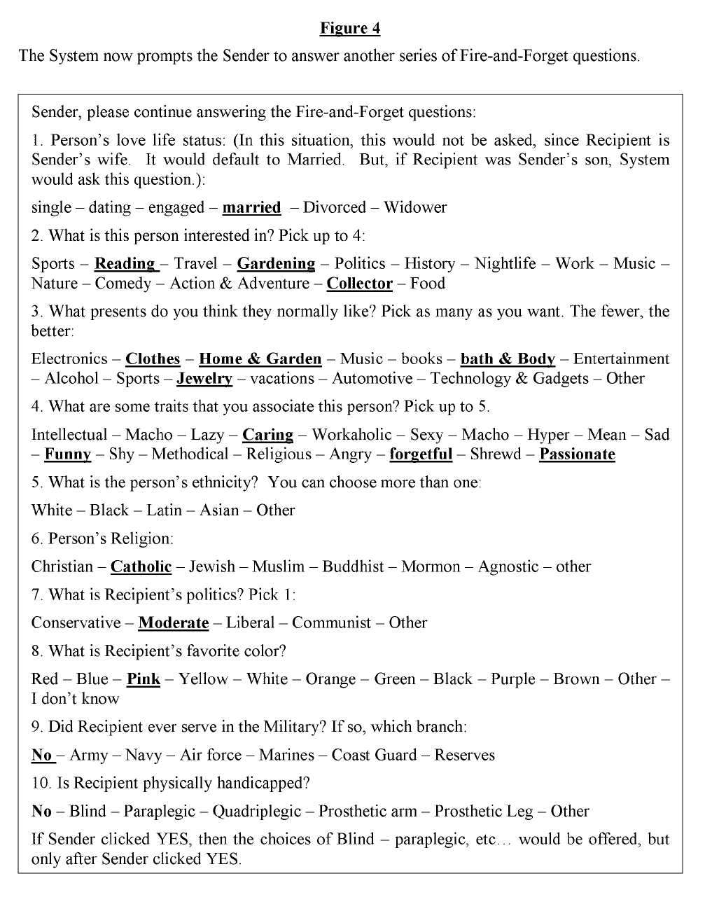

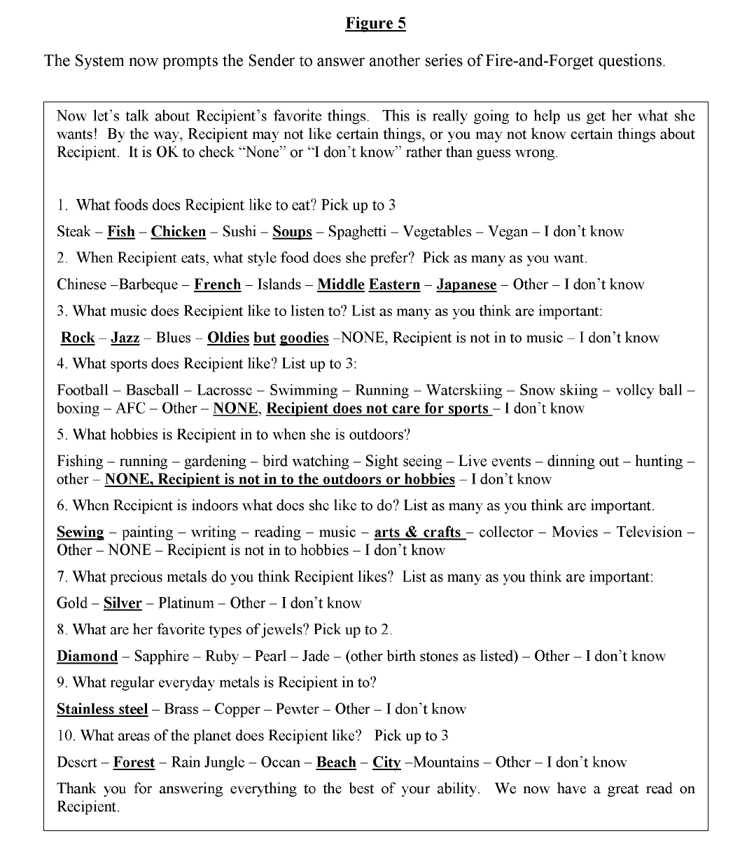

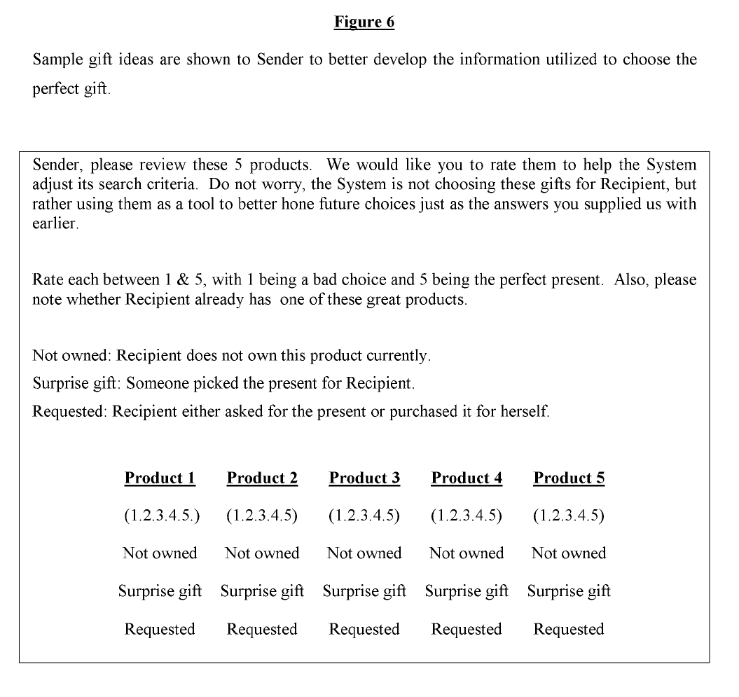

The AI software will also cross check Sender's answers with one-another to determine accuracy. For example, Sender listed his wife as 5′1″—145 pounds and gave her a rating of 3 when it came to her physical makeup [FIG. 3]. This seems sensible. However, if Sender said Receiver was 5′8″—120 pounds, but stated later she had a 3 body, the System will consider that accordingly. The System will use, for example, the height—weight diagnosis measuring System found standard in a doctor's office, which considers your age, weight and height to determine body fat and structure. Similarly, the AI software will cross-reference the Sender's entries for this Recipient against the information entered by other Senders regarding the same Recipient. For example, if another Sender has not selected “caring” [FIG. 4], but has instead listed “mean,” an almost polar opposite of caring, the AI software would consider and weigh this anomaly accordingly in assigning points to the answers provided.

The AI software will also be able to utilize, where appropriate, trends and analytic data from the target market segment. This may occur when Sender's and Recipient's relationship is far removed, making it difficult to enter personal information about the Recipient. In this instance, the system will have to use Profiles from people that were created that match that Recipient, but were created by someone closer. For example, a Sender filling out information for its grandson aged twenty-three, may not know much about his daily life, therefore the system could pull from a twenty-three-year-old who has the same basic criteria, (e.g., geographic region, race, religion, etc) but had their Profile filled out by their older brother, or perhaps, by themselves when they were buying for someone else.

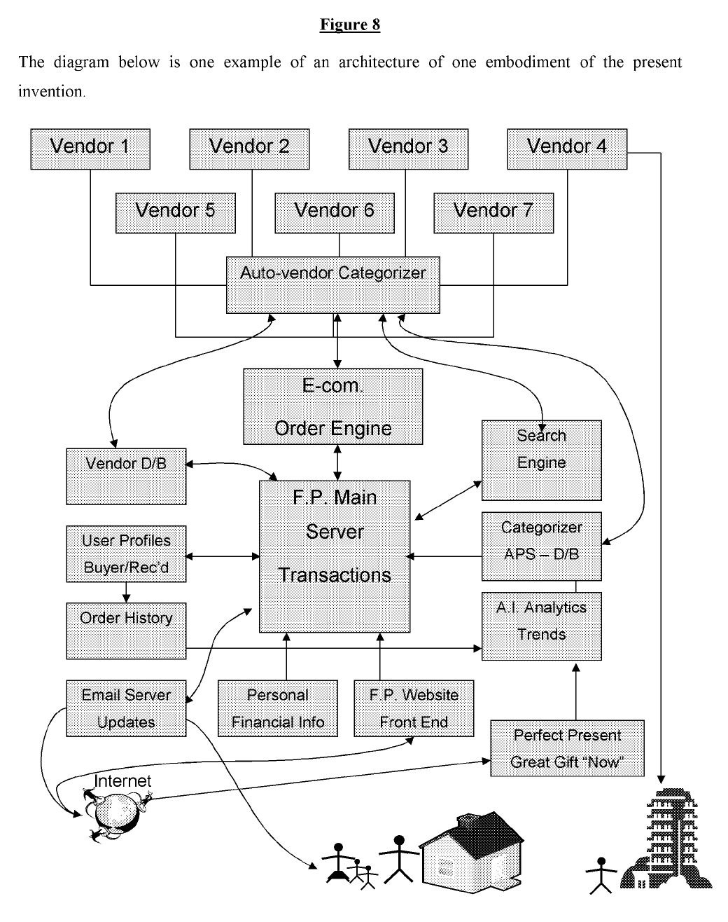

After all of this information has been inputted, the System displays (via the web interface) examples [FIG. 6] of what the AI software has decided might be great choices for Recipient based on all the information in the database relating to this Recipient. However, these options are not the ultimate choices that the AI software will make. This is only an exercise in attempting to determine if the System is on the right track in selecting the perfect gift. Sender will have the ability to rate the gift options and point out whether Recipient already has the items shown (this will remove the possibility of these items being selected as future gifts), and, if so, whether it was a requested gift, or whether it was received as a surprise present. All of this information provides the System with a larger knowledge base, and consequently, the AI software can select a more appropriate gift.

After this process, the System thanks Sender (through the web interface), and the session is over. The AI software then considers all of the information entered by Sender, as well as information entered by other users of the System, and selects the perfect gift for Recipient. This gift is selected, ordered and shipped to arrive on or before the occasion initially set out by Sender, i.e., Recipient's birthday. However, the gift is not selected too early. For example, if Sender wants a gift sent for Recipient's birthday which is 8 months away, the System will not select a gift until the occasion date is much closer in time, else, prospective products that are released in the interim would not be considered.

The System is also enabled to populate user's (either Sender or Recipient) calendar application, such as Outlook or Google Calendar. For example, when Sender is planning trips, whether business or personal, it is aware of upcoming events in its life. Unlike in Outlook, where Sender is the only person uploading special dates, when the System links up to Sender's social calendar, it will populate it with all the dates its social “Future Present” network has added, such as the birth of Sender's new Grandson. Such automatic calendar population avoids the risk of having a business meeting overlap with the kid's first Birthday. For example, that birthday date could have been entered by Sender's daughter, who updated either her profile and/or her new son's profile. Moreover, she is likely to have a baby shower registry on the System, that she will either create on the System or the System will pull that date from the place she registered. The System will also allow a user to register at multiple places and act as a portal. Currently, a user can only register at one or the other, or both, but they are no linked and there is no feedback to help you with gift selection for that person as a parent. The System may also list all of the user's old presents and user's rating on them.

The System will also offer the Recipient of the gift an opportunity to provide feedback (i.e., rate the present) and add more detail to its profile. The feedback doesn't have to be given back to the person that purchased the gift, but rather to the System, so the System can better select future presents for the person, regardless of who uses the System to purchase that person a gift in the future. Recipients may be enticed to enter this information by being offered “Future Present Points.” Future Present Points are linked to a User's account. That means that the User can allocate them however he wants. A User can use the points towards free shipping, percentages off certain merchandise or purchasing personal assistant time that the company will offer for a fee.

Entering this information about the future event, i.e., Recipient's birthday, will enable the System to remind Sender years into the future about the upcoming occasion, as well as select a present(s) for the occasion. The genius of this System is that Sender will never have to remember this occasion again; the Sender has peace of mind. For example, Sender enters info about his wife's birthday in May 2007. The System arranges for a gift to be sent. Sometime in 2008, the System will remind Sender of this upcoming birthday. This can be done by reminder emails or other means. The System will also have a default safeguard where if Sender fails to respond to reminder emails, a gift is automatically selected (based upon information in the database), purchased and shipped to the Recipient in time for the occasion.

Furthermore, the System does not only notify Sender of occasions it has entered, but it also uses the AI software to notify the Sender of potential occasions. For example, Sender has a daughter who will turn eighteen in six months time. The AI software would reason that Sender's daughter may be graduating high school in the near future. Thus, the System would also contact Sender about this upcoming occasion. The System would ask whether Sender would like to send a gift for this momentous occasion, and if so, asks for the date of the graduation. If Sender chooses to send a gift, the System would remember this selection for Sender's other daughter who will turn eighteen in 3 years and remind Sender at the appropriate time. Therefore, in this, as well as other ways, the System is a learning system which continually improves the more it is utilized.

### Another Embodiment

Many people are indecisive. For those people it is often difficult to select the appropriate gift for their friends, family and/or acquaintances. This will routinely lead to a disappointing choice, and a waste of valuable time and effort. According to another embodiment of the present invention, the gift Sender can go online looking for a present to purchase immediately without having the burden of selecting an appropriate gift.

The web interface first asks the Sender whether they want the present to be wrapped and shipped directly to the Recipient, or whether they are just looking to purchase a present and have it shipped to Sender for personal delivery.

The interface then queries the Sender for general information regarding the Recipient that they are buying the present for. For example: Age, sex, likes, dislikes, hobbies, weight, color, etc. This occurs in three sets of questions. After each set of questions is completed, Sender is given gift options. The Sender's answers are inputted into the Recipient's Profile in the database. This information allows the AI software to display the most appropriate gifts to the Sender. The first set of questions is very general, however, many people will find a gift in the first set of gift options, but for those who do not find the perfect gift, there are 2 more sets of questions that can help narrow the search. There are 3 sets of questions in total for the person receiving the gift. (Later in the search, the questions are geared toward the purchaser.).

If the Sender has exhausted all 3 sets without choosing a gift to send, they may continue in one of two ways: (1) Continue using the AI software to generate gifts options for free; or (2) Have a professional help them over electronic means. They will be charged a fee based on time spent or cost of product.

Assuming the Sender chooses to continue using the AI software for free: Selection then turns into a keep or reject selection process, where after the 4th set of questions they are given 5 choices, but if they do not want to select one of the 5 as the present, they must at least choose one of the five as a “keeper” and then when the 5th offering of five comes on the screen, one of the five will be the one they decided to keep from the 4th present group. The 6th set of gift choices would then have 2 “keepers” and therefore 3 new items to select from. The 7th set of gift choices would have 3 “keepers” with only two new selections. The 8th set of gift choices would consist of 4 “keepers” with only one new offering. If at that point there was still not a present they wanted to purchase, the System would then ask which of the 5 “keepers” they liked best and which they liked least. They would then be asked another set of questions, which would relate to the Sender of the gift, versus the Recipient. Once those questions are answered the process starts once again from the point of the 4th set of questions, i.e., poker style, and then asks more detailed questions after each set is presented to the purchaser. If the person searching the site gets to the eighth set of gift choices again, the System will automatically direct them to the second choice, which is the live assistant.

Having a professional help them over electronic means: The purchaser must first input their financial information (for example, credit card information) in order to receive help from a System representative. They will be charged a fee based on time spent or cost of product.

In accordance with another embodiment of the present invention, the System is enabled to provide the user (for the profile purposes) with the option of having the System have an add-on to its default browser in real time (e.g., spyware). The System's AI would utilize websites visited, topics searched, and questions asked on all search engines, such as www.Google.com, www.Ask.com and Microsoft's Internet Explorer, as well as pull data for purchases made from all major online retailers, including www.Amazon.com and www.Ebay.com to name a few.

By utilizing a spyware software package that is transparent in nature to the web-surfer/user, the system could utilize the AI to determine likes and dislikes, on both a conscious and subconscious level. By compiling data via search requests, results, length of stay on certain sites (e.g., page view statistics), chat rooms visited and time of stay, the System's AI can learn certain pertinent profile information on the user that the user would not normally disclose in a formal email questionnaire, i.e., their sexual orientation, their racial preferences, if any, mental or physical health disorders, and other user's private characteristics. Such personality traits will be able to fine tune search results for a perfect present, both in something the person would want to give someone, and for their personal profile down the road on what they would want to receive as a gift.

Furthermore, buying habits—what people bid on even though they do not buy the merchandise they bid on—is valuable information. The AI can determine what intrinsic value a person places on a present. For example, if a user continuously bids on Disney merchandise from the 70's, such information could tell the system that something from that era and/or Disney has a great value to that person and if they look for dolls on the system, pick Disney over all other dolls, or suggest vacations to Disney Land, even though the buyer has no idea that the recipient wants to visit Disney.

addition, the System could periodically (at user's choice) give a pop-up question or selection menu and ask the user to rate the product they are viewing on any particular site. For example, if the user is at www.Macys.com and is looking at a cook wear set. The AI will know they are viewing a product and ask the user what they think of the product. A rating scale is assigned to products (e.g., 1-5) that a user utilizes when selecting a product on the System's (i.e., www.FuturePresent.com) website.

Although the present invention has been described in terms of specific embodiments, it is anticipated that alterations and modifications thereof will no doubt become apparent to those skilled in the art. It is therefore intended that the following claims be interpreted as covering all such alterations and modification as fall within the true spirit and scope of the invention.

What is claimed is:

1. A method for determining a selection of gifts for an occasion, said method comprising the steps of:
(a) entering information into an interface, said information comprising:
(i) Occasion date;
(ii) Characteristics of the sender and/or recipient;
(b) storing said information in a memory; and
(c) utilizing Artificial Intelligence Software to determine the selection of gifts for said recipient based upon the information stored in said memory.

2. The method according to claim 1, wherein the Artificial Intelligence Software automatically selects one or more gifts from the selection of gifts for the recipient;
and communicates that determination to vendors for the purchase and delivery of said one or more gifts before the occasion date.

3. The method according to claim 1, further comprising the steps of:
communicating the possible gifts to a decision maker for determining which one or more of the gifts should be purchased for the recipient;
and communicating that determination to vendors for the purchase and delivery of said one or more gifts before the occasion date.

4. The method of claim 1, wherein said information is pulled automatically from the sender's and/or recipient's social network sites.

5. The method of claim 4, wherein said memory is dynamic and is updated automatically with changes in said information.

6. The method according to claim 3, wherein the decision maker is a recipient.

7. The method according to claim 1, wherein a decision maker (sender/recipient) is presented questions, the answers of which are also used as information by the Artificial Intelligence Software to determine possible gifts;
and communicating said possible gifts to the decision maker for determining which one or more of the gifts should be purchased for the recipient.

8. The method according to claim 4, wherein the decision maker determines which one or more of the gifts should be purchased for the recipient;
and communicating that determination to vendors for the purchase and delivery of said one or more gifts before the occasion date.

9. The method according to claim 4, wherein the decision maker continues using the question and answer routine to aid the Artificial Intelligence Software in determining a new set of possible gifts until the decision maker determines which one or more of the gifts should be purchased for the recipient;
and communicating that determination to vendors for the purchase and delivery of said one or more gifts before the occasion date.

10. The method according to claim 4, wherein after the possible gifts are communicated to the decision maker, the decision maker receives help from a professional to determine a new set of possible gifts until the decision maker determines which one or more of the gifts should be purchased for the recipient;
and communicating that determination to vendors for the purchase and delivery of said one or more gifts before the occasion date.

11. The method according to claim 3, wherein said communication to the decision maker is via email.

12. A method for determining a gift for a potential occasion, said method comprising:
(a) utilizing Artificial Intelligence Software to determine a potential occasion based on information stored in a memory;
(b) notifying a decision maker of the potential occasion;
(c) determining whether the decision maker wants to send one or more gifts to a recipient for the potential occasion; and
(c) utilizing Artificial Intelligence Software to determine one or more gifts for said recipient based upon the information stored in said memory.

13. The method according to claim 8, wherein the Artificial Intelligence Software automatically selects one or more gifts from the possible gifts for the recipient;
and communicating that determination to vendors for the purchase and delivery of said one or more gifts before the occasion date.

14. The method according to claim 8, further comprising the steps of:
communicating the possible gifts to a decision maker for determining which one or more of the gifts should be purchased for the recipient;
and communicating that determination to vendors for the purchase and delivery of said one or more gifts before the occasion date.

15. The method according to claim 8, wherein the decision maker is presented questions, the answers of which are also used as information by the Artificial Intelligence Software to determine a selection of gifts;
and communicating said selection of gifts to the decision maker for determining which one or more of the gifts should be purchased for the recipient.

16. The method according to claim 11, wherein the decision maker determines which one or more of the gifts should be purchased for the recipient;
and communicating that determination to vendors for the purchase and delivery of said one or more gifts before the occasion date.

17. The method according to claim 11, wherein the decision maker continues using the question and answer routine to aid the Artificial Intelligence Software in determining a new set of possible gifts until the decision maker determines which one or more of the gifts should be purchased for the recipient;
and communicating that determination to vendors for the purchase and delivery of said one or more gifts before the occasion date.

18. The method according to claim 11, wherein after the possible gifts are communicated to the decision maker, the decision maker receives help from a professional over electronic means to determine a new set of possible gifts until the decision maker determines which one or more of the gifts should be purchased for the recipient;
and communicating that determination to vendors for the purchase and delivery of said one or more gifts before the occasion date.

19. A system for determining a gift, said system comprising:
(a) an interface for providing information to the system, said information comprising:
(i) Occasion date;
(ii) Characteristics of the recipient and/or sender;
(b) a memory for storing said information;
(c) Artificial Intelligence Software for determining a possible gifts for said recipient based upon the information stored in said memory;
(d) an interface for communicating the possible gifts to a decision maker;
(e) an interface that allows the sender to designate one or more gifts from among the possible gifts as selected one or more gifts; and
(f) a link to vendors for the purchase and delivery of the selected one or more gifts before the occasion date.
